(19) United States
(12) Patent Application Publication
(10) Pub. No.: US 2019/0083219 A1
(43) Pub. Date: Mar. 21, 2019

(54) SYSTEMS AND METHODS OF FACIAL FEATURE SCANNING

(71) Applicant: NOVEL TECHNOLOGIES INC., Toronto (CA)

(72) Inventor: Shlomo Erez SHARER, Toronto (CA)

(21) Appl. No.: 16/087,232

(22) PCT Filed: Mar. 22, 2017
(86) PCT No.: PCT/CA2017/050365

§ 371 Date: Sep. 21, 2018

Related U.S. Application Data
(60) Provisional application No. 62/311,443, filed on Mar. 22, 2016.

(51) Int. Cl. A61C 19/05; A61C 9/00; A61C 13/00

(52) U.S. Cl. CPC A61C 19/05; A61C 9/0006; A61C 13/0004; A61C 9/004

(57) ABSTRACT

There is disclosed a system for creating a dental device for use in a mouth of a patient. The system includes a scanning device comprising a plurality of sensors; a processor in electronic communication with the scanning device; an impression tray; a fiducial device connected to the tray and shaped and configured to provide tracking data to the sensors; wherein the scanning device comprises a plurality of sensors adapted to monitor and capture orientation data and movement data regarding the impression tray and transmit such orientation data and movement data to the processor; and, wherein the processor is adapted to an render electronic image of a dental device suited to the needs of the patient based on the orientation data and movement data.

### FIELD

The present disclosure relates to scanning and modelling and manufacturing systems and methods, techniques and, more specifically, to improve systems and methods of scanning human features, rendering the same and manufacturing related devices.

### BACKGROUND

The term “dentures” generally refers to objects or devices replacing some or all missing teeth, and the support structure of those teeth. Dentures are commonly referred to using more specific terminology such as Complete Dentures or Partial Dentures or Dental Prosthetics. Dentures typically include three distinct components:

1) Denture base: a thin layer which contacts and overlies the dental ridges of the mouth (i.e., alveolar ridges). The base is generally composed of acrylic but other materials are suitable. Material requirements include formability into a desired shape, shape-stability at and within a wide margin of body temperature, be biologically inert, and having enough strength to withstand bite force. It is beneficial to be able to carry a colour which matches that of gingiva or to be translucent. It is common to use one of several acrylics (e.g. PMMA) or plastics. Other materials used are nylons which are specifically formulated for strength. Metal bases have been used and still are in use, mainly, for partial dentures. Glass and a variety of resins can also be formed. Other materials that may be used will need to meet the requirements above.

2) Teeth: these are placed components, typically numbering 1-14 per dental ridge (it is possible but is seldom needed, to place more teeth where the ridge is especially long); fewer teeth may be placed in partial dentures where some natural teeth are present, and may be placed individually or in groups of multiple units. There is a need for an improved process by which a set of several (e.g., 2-14) teeth may be produced as a single object. It would be advantageous for these to be formed by use of additive process such as 3d printing or by subtractive process such as milling techniques. In either case, the object consisting of multiple teeth can be placed onto the denture base as a single item, thereby further streamlining the process. These synthetic teeth are generally formed of plastic or porcelain. Other materials may be used, as is known in the art, subject to limitations such as ability to be formed in colour(s) of choice. Additionally, the teeth must be such that they can merge chemically (either directly or by use of a bonding material) or mechanically (by formation of an undercut or other retaining shape such as an anchoring socket formed into the base of the tooth) to the denture base material.

3) Support structure for the teeth: This resembles gingiva (gum), and serves to connect the denture base and the teeth. This is generally formed of acrylic or plastic. In the finished product, it is generally processed as a single unit which includes the base. However, during the construction phase it is kept separately and is often formed of wax so that it can be altered readily during that phase and so that the position of the teeth can be altered easily as teeth are affixed to the support structure. Wax is the overwhelmingly the material of choice but various malleable materials may be used, as will be appreciated by one skilled in the art. The choice to use wax is often made because it can be provided in various hardnesses, it can be softened by application of heat, and can set fairly quickly. Other generally possible materials would be thermoplastics and designed resins and clays.

The foregoing has been provided as general background to aid in understanding the discussions of fitting and fabrication following herein. Presently, dentures are fitted for and rendered locally in most jurisdictions. Commonly, the provision or fabrication of dentures is restricted by local law or regulation, typically specific to particular accredited professions, generally dentists or denturists. Despite the ubiquity of such processes, known variations exhibit numerous deficiencies, as detailed herein.

The process of fabrication of dentures generally includes obtaining a model of the dental ridge (i.e., maxillary-upper jaw and/or mandibular-lower jaw). The model will show teeth, if present, and the support structure (gum and underlying bone formation) and its features.

A container (also referred to as an impression tray) is used and approximately but loosely fits in the mouth and on the upper or lower ridges. Such containers are widely available, with manufacturers generally making available several sizes of container, specific to each of the upper (maxillary) and lower (mandibular) ridges.

An impression material is applied to and fills the impression tray. The malleable impression material will set to a rigid and more stable shape. The tray containing the impression material is placed in the mouth, impressing the ridge of choice. The tray is held in position for a time sufficient for the material to set. Following the setting period (1-3 minutes, typically), the tray with the impression material attached to it (this is referred to in the art as, for example, a tray-impression complex) is withdrawn. The process is repeated to obtain an impression (i.e., a negative image) of the other jaw.

The model (tissue replica) is generated by pouring a fluid substance, typically a gypsum product, into the impression. The fluid substance sets into a rigid and stable object. This stable object is expected to be a replica of the jaw and dentition. Following the setting of the model, it is separated from the impression-tray complex.

The models of the dental ridges and support structures permit the determination and construction of the denture bases. The bases are a thin covering of just that portion of the model which will represent the pressure-bearing tissue area. The borders of the bases can be determined by a professional having knowledge and understanding of oral anatomy, when presented with an accurate model. However, these models do not provide sufficient information to determine the amount and shape of support structure that must be constructed or the position(s) along that structure at which to place the teeth. This is a significant deficiency that can lead to a need for repeated construction of end products, and/or patient dissatisfaction by way of uncomfortable or otherwise poor fit.

In some instances, for example, when teeth are initially extracted, their previous location can be discerned from the apparent position of the remnant socket in the model, but this is only if the model is produced very shortly after the time of extraction. With passage of time, the ridge shrinks and relevant features become less distinct. As such, determination of the size and shape of the ridge (also referred to herein as a support structure), which is important, becomes increasingly difficult. Existing methods include determining a desired position of the teeth, often focused on aesthetic rather than functional objectives, and then fill the intervening space between the teeth and the base with the support structure of what may be a reasonable but very likely not optimal anatomical shape.

This faulty determination is in part due to the complexity of the anatomical environment, the number of geometric variations at play and limitations of available products. For example, synthetic teeth are generally purchased in sets, and are available from a multitude of producers. Teeth are either constructed of plastic or porcelain and are generally sold as sets consisting of a known configuration of fourteen teeth for each ridge of a functioning adult dentition. Each producer makes available a variety of molds for each set and a variety of shades. A complete inventory of teeth that can service a normal population may require the stocking of hundreds of sets of teeth. Posterior teeth generally are available in several cusp angles from each producer. Typically cusp angles would be 0, 10, 18, 33 degrees. These molds are provided to accommodate the angular path of the mandible as it moves laterally in the act of mastication (chewing).

There are numerous areas in which a lack of precision and an acceptance of approximations rather than more exact specifications in existing systems lead to less than optimal results, and a similar level of performance.

For example, the synthetic teeth are placed in an arch shape which approximates the general shape of each ridge. Since teeth are not placed directly onto the ridge but each at some particular spacing from the ridge (allowing for the appropriate replacement of resorbed support structure), that particular spacing must be determined (in terms of distance from the support structures). Moreover, teeth can be placed in a wider or narrower arch and at any position and orientation with respect to each ridge. Among the objectives for proper positioning of teeth are that the teeth are esthetically pleasing, and functionally effective. Minor changes in the positioning of the teeth can have significant effects on the aesthetics and function of the denture. One difficulty in determining an aesthetically appropriate position is that the aesthetics are largely a function of characteristics of the face and head of the specific patient and those of the movement of that person's mouth. However, and quite problematically, during the construction phase of the denture, there is little to no information available regarding these characteristics. More specifically, there is no known method to reliably and accurately relate the position of the teeth to the image and appearance of the face of the patient or to approximate and account for the particular movement capabilities and tendencies of his/her lips and/or jaw. Placement of teeth in locations suitable for proper function also requires the determination of the movement and position of the jaws when the patient speaks and eats. This information is also not available during the construction of the teeth/dentures.

These informational deficiencies lead to unpredictable and inconsistent results, particularly vis-à-vis installed performance of dentures in terms of aesthetic and functional considerations.

Known methods aimed at surmounting this limitation include placing a try-in denture in the mouth of the patient and conveying feedback to the fabricator of the denture from the patient and practitioner with respect to the aesthetic objectives and functional deficiencies of the try-in dentures. The fabricator is expected to institute changes in accordance to the request and the dentures can be retried in the mouth of the patient. This process can be repeated multiple times until the dentures are accepted by patient and practitioner. This is a tedious, time-consuming and expensive “trial and error” approach to the process of providing dentures.

For further context in understanding how these deficiencies occur, it is noted that some of the information is gathered in a manner as is generally described below:

A wax rim is constructed on each model which has pre-set dimensions. The dimensions of the rims are based loosely on an understanding of population averages. This methodology is somewhat analogous to the way garments are sized. However, the applied logic, such as it is, is faulty, as the fit for dentures must be very customized and, indeed, personalized; and, it must be much more precise so as to meet aesthetic and functional requirements for each patient.

The upper rim is placed in the mouth of the patient and marks are recorded onto the rim to generally indicate the midline of the patient's face, and a horizontal plane which is parallel to a line between the patient's eyes (this plane is thought in the art to be generally appropriate for an approximation of and reference to the right-left orientation of the teeth) of a given patient, the extent of the upper lip when relaxed and when smiling and the position of the corners of the lips are also recorded. If the rim is too visible, in a given orientation, it can be reduced and returned for another marking appointment (with associated patient/service provider inconvenience and costs). If the wax rim provides an inappropriate level of contact with the lip (i.e., too much or too little lip support), it can be reshaped (again, adding time, cost and inconvenience).

The patient is instructed or is manipulated to bite at the position at which the heads of the mandible are inserted into their sockets at the temporomandibular joints. That bite position is known in the art as the “Centric bite” or “Centric position” and is considered the position of maximum biting force. It is also viewed as the only repeatable mated position of the jaw portions and is viewed as the most comfortable closing biting position, and the position at which natural teeth are expected to fully interdigitate.

This recording can be repeated to ensure that it is correct (as it is repeatable only if it is correct). When that centric position is determined, the wax rims can be softened and allowed to merge upon biting. As a consequence, the bite rims fuse and can be removed together.

As the rims fit both the ridges and the models, it is expected that the merged bite rims can be transferred back to the models and relate the position of the models to each other in the centric bite which was recorded in the mouth. In that position, the models are placed in a device which mimics the opening and closing movements of the jaw at the centric position. This device is called an articulator.

More additional bite recordings may be obtained in instances where the dentures to be made are required to meet more rigorous standards. Such dentures are commonly referred to as a “precision-set denture”. The formation of such dentures incorporates information pertaining to the position of the jaw when it is in, for example an anterior position (as when a person bites into an item with their front teeth) and when the jaw is in lateral positions on both the right and the left (as in when food is being chewed). These recordings are made by placing a thin rim of wax or another malleable material between the rims (while in the mouth) and manipulating the patient to move their jaw to each desired position and close in that position. When the recording material is set, the patient is asked to open their mouth and the recording material is withdrawn (with this process being repeated for each position.

For precision-set dentures, when the models are placed in an articulator, it must be one which can be positioned in a variety of bite positions and not merely permit for opening and closing in the centric single bite position. This type of articulator is referred to as a “fully adjustable articulator”. The joints of that articulator can be set so that the position of the mandible can reproduce various bite positions.

Once the models are placed in proper orientation, teeth are taken from stock and are placed on the rims, respecting the recording markings. They are positioned, one at the time in a rather time consuming process. This process is an art, supported by science rather than a purely mechanical, scientific process. As such, high levels of experience and skill are required to achieve even possible results.

The resulting “set-up” is tried in the patient's mouth to verify the appearance and function and to confirm that the previously recordings are correct. Regardless of the recordings, this allows the patient to view the appearance and either accept the appearance or direct changes. This step, known in the art as, “try-in,” is crucial in order to obtain patient consent and acceptance of the appearance of the denture.

In the event that the appearance of the dentures is not acceptable (let alone optimal) a reset of teeth is required. This is a very time and effort consuming process, with substantial associated costs. Moreover, if the bite recordings are recognized at try-in to have been in error, a new bite(s) must be recorded and the models must be re-articulated to the new bite recording. The teeth, then, need to be reset in the new bite. This is unduly cumbersome and time-consuming. This “trial and error” process is a highly significant deficiency of processes presently known in the field. The difficulty in recording the bite is twofold: the patient needs to be instructed or manipulated to bite in the centric position. Often, the patient is not clear on this positioning and/or is otherwise unable to comply. When manipulating the jaw into centric bite, a natural reaction is to stiffen the jaw and eject forward. The bite, as such, is sometimes recorded as being in centric position, when that is not the case.

Another issue may be that even if the patient has closed into contact at the centric bite, the bite force between the bite rims is unbalanced. Thus, one or both rims torque in the mouth. However, the appearance is that they are in even contact along the length of the rim when the actual case is that one or both rims are unseated from the ridge; therefore, the recorded bite is not representative of the true positional relationship between the ridges. Compounding this problem is the matter of the vertical dimension (separation between the ridges at the centric bite). It is known that changes in the vertical dimension can and do alter the position of the centric bite along not vertical the vertical axis but also on the horizontal axes (front-back; side-side). Where the vertical dimension has to be changed to meet aesthetic and other functional objectives, the centric bite recording is compromised and must be obtained again at the new vertical dimension.

The inefficiency of this trial and error process has been brought even more so to the fore in view of increased regulatory and public concentration on hygiene issues. As such, reviews of known processes have shown problems resultant from risks associated with high volume handling and multi-stage and/or repeated transfers of materials. A particular area of concern is transfers of impressions from mouth to laboratory, and back and forth therebetween. The fabrication of the models and the handling of those models in the laboratory after they have been in biological contact is a significant issue. In addition, the placement of bite rims in a mouth after having been fabricated in the lab, amongst a myriad of possible contaminants is of concern, as is the return of those rims and their handling in transit or otherwise between fabrication, repair and try-in, and any subsequent returns to the lab.

Although there is a protocol for safe carriage of this process, the infection danger for patient and provider remains a concern. Moreover, the cross-infection from patients remains a significant issue.

Once the try-in dentures are approved by the patient, the denture can be processed and fabricated in accordance with methods well known in the field.

When considering fitting and, the importance of bite recording in particular, it is imperative to note that devices must be placed in an orientation to each other which duplicates (not merely emulates) the orientation of the actual jaws in particular and expected circumstances. It is also essential that placements are explored and mimicked wherein they are positioned in a proper orientation with respect to the head, face and temporamandibular joint (TMJ).

Examples of reasons underpinning this need are detailed below:

The mandible is a unique bone, in that it is capable, as a normal function, of being completely disarticulated at its joints. As a result, the mandible can move freely along any path and be in any position within its range of motion. When the mandible remains articulated, it can still move but its motion is restricted to a narrow, repeatable rotation. In its most flexed position along this path, (i.e., flexion of the masseter muscles, or cheek muscles), the jaws are at their closest normal position to each other. In that (centric) position, natural teeth are fully interdigitated (i.e., positionally mated in complementary fashion).

The unique capabilities of the mandible are not captured by known techniques of bite recording. Indeed, looking particularly to one alternative recording method, namely Gothic Pin Arch Tracing, records, to some degree, the relative position of the jaws to each other at maximal positions along the mandible's range of motion. This method uses a pin that is placed between two trays or devices, with each covering one of the ridges. The patient is instructed to move their jaw to its maximal positions and the pin traces those movements along the surface. While this method captures some aspects of normal movements of the patient's jaw, it is still deficient. This method fails to account for forces applied to or on the trays deriving from a single point of contact of the pin which can cause imprecise and inaccurate measurements based on positional deviations of such trays or devices. This method presumes or is indifferent to a stability of the trays or devices, or a similarity to normally positions and movements that does not exist.

As such, there is a need for improved systems and methods which eliminate or mitigate some or all of these issues, in respect of fitting for and facilitating fabrication of dentures. It will be appreciated that improved methods of precisely scanning, capturing and monitoring facial features and related function and movement through a range of motion will also permit use in applications beyond denture fitting and production.

### SUMMARY

There is disclosed herein a system for creating a dental device for use in a mouth of a patient, the system including: a scanning device comprising a plurality of sensors; a processor in electronic communication with the scanning device;

an impression tray; a fiducial device connected to the tray and shaped and configured to provide tracking data to the sensors; wherein the scanning device comprises a plurality of sensors adapted to monitor and capture orientation data and movement data regarding the impression tray and transmit such orientation data and movement data to the processor; and wherein the processor is adapted to an render electronic image of a dental device suited to the needs of the patient based on the orientation data and movement data.

In another disclosed aspect, the scanning device includes a frame for retaining the sensors in desired positions relative to the patient.

In another disclosed aspect, the scanning device further comprises a mount selectively holding the frame in and moving between a plurality of monitoring positions.

In another disclosed aspect, the sensors comprise a plurality of video cameras.

In another disclosed aspect, the frame comprises a substantially square outer frame portion and an inner frame portion, wherein the inner frame portion is mirrored and operationally directed towards the patient, and wherein the cameras are attached to the outer frame portion.

In another disclosed aspect, the fiducial device comprises a retention portion and one or more visible indicia comprising relief characteristics, colour, shape, and wherein the visible indicia are formed, etched, or marked.

In another disclosed aspect, the fiducial device is integrally formed with the impression tray and visible outside the user when the impression tray is in the mouth.

In another disclosed aspect, the system further comprises an output device for providing a viewable electronic rendering of the dental device in and about the mouth.

In another disclosed aspect, the system further comprises a fabrication device for producing the dental device based on the rendering.

In another disclosed aspect, the fabrication device comprises a 3-dimensional printing device.

There is also disclosed an impression tray for use in creating a 3-dimensional rendering of one or more body parts of a patient, the tray comprising: a retention portion for fixing the tray relative to the patient; an indicator portion connected to the retention portion and bearing one or more visible indicia; wherein the retention portion comprises one or more members shaped to receive a bite of the patient; and, wherein the indicia comprises relief characteristics, colour, shape, and wherein the visible indicia are formed, etched, or marked on the tray.

In another disclosed aspect, the indicator portion and retention portion are integrally formed.

There is also disclosed a method of scanning the face of a patient, the method comprising the steps of: placing an impression tray in the mouth of the user with one or more visible indicia outside the mouth; scanning a plurality of images of the face of the patient using a plurality of sensors while the patient moves its jaw through a set of positions and movements; processing the images using a computer to form an electronic rendering of the bite of the user; further processing the images using the computer to generate an electronic rendering of a dental device in the mouth; outputting to a visual output device imagery of the rendering for review; adjusting one or more parameters of the rendering based on the review; fabricating the dental device by a fabrication device in electronic communication with the processor.

### FIGURES

The systems and methods discussed herein may be better understood by referring to the following Detailed Description and accompanying drawings, in which like reference numerals indicate identical or functionally similar elements:

FIG. 1 is a front, schematic view of a system disclosed herein;

FIG. 2 is a side view of the system of FIG. 1;

FIG. 3 is a front schematic view of another embodiment of a system disclosed herein, with a ceiling or top-side mount for a frame;

FIG. 4A is a left side view of a patient with an impression tray in her mouth;

FIG. 4B is a left side perspective view of the patient of FIG. 4A;

FIG. 4C is a front view of the patient of FIG. 4A;

FIG. 4D is a right side perspective view of the patient of FIG. 4A;

FIG. 4E is a ride side view of the patient of FIG. 4A;

FIG. 4A is a left side view of a patient with an impression tray in her mouth;

FIG. 5 is an enlarged view of FIG. 4C;

FIG. 6 is a front view of the patient shown in FIG. 5, with different indicia on the impression tray;

FIG. 7A is a left side view of upper and lower denture bases;

FIG. 7B is a left side view of a patient;

FIG. 7C is a left side view of the patient of FIG. 7B, with the bases of FIG. 7A shown therein;

FIG. 8A is a front view of the upper and lower denture bases of FIG. 7A;

FIG. 8B is a front view of the patient of FIG. 7B;

FIG. 8C is a front view of the patient of FIG. 7B, with the bases of FIG. 7A shown therein;

FIG. 9A is a front view of a rendering of a patient with an impression tray in its mouth;

FIG. 9B is a left side perspective view of the rendering shown in FIG. 9A, with frontal and mid-sagittal planes also shown therein.

FIG. 10A is a top view of a lower portion of an impression tray;

FIG. 10B is a top view of an upper portion of an impression tray;

FIG. 11 is a front view of the patient shown in FIG. 6, with different indicia on the impression tray; and

FIG. 12 is a left side perspective view of the patient shown in FIG. 11.

FIG. 13 is a front view of a scanner in an open configuration.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Similarly, some components and/or operations may be separated into different blocks or combined into a single block for the purposes of discussion of some of the embodiments. Moreover, while the various embodiments are amenable to various modifications and alternative forms, specific embodiments have been shown by way of example in the drawings and are described in detail below. The intention, however, is not to limit the particular embodiments described. On the contrary, the embodiments are intended to cover all modifications, equivalents, and alternatives falling within the scope of the disclosed embodiments as defined by the appended claims.

### DETAILED DESCRIPTION

There is disclosed herein improved systems 100 and methods 300 wherein a three-dimensional scan is performed and its results used to obtain an image or images and renderings, of the head and face of a patient. While this specific functionality is stated, one skilled in the art will appreciate that scanning of other items or physical features may also be performed using systems and methods herein disclosed.

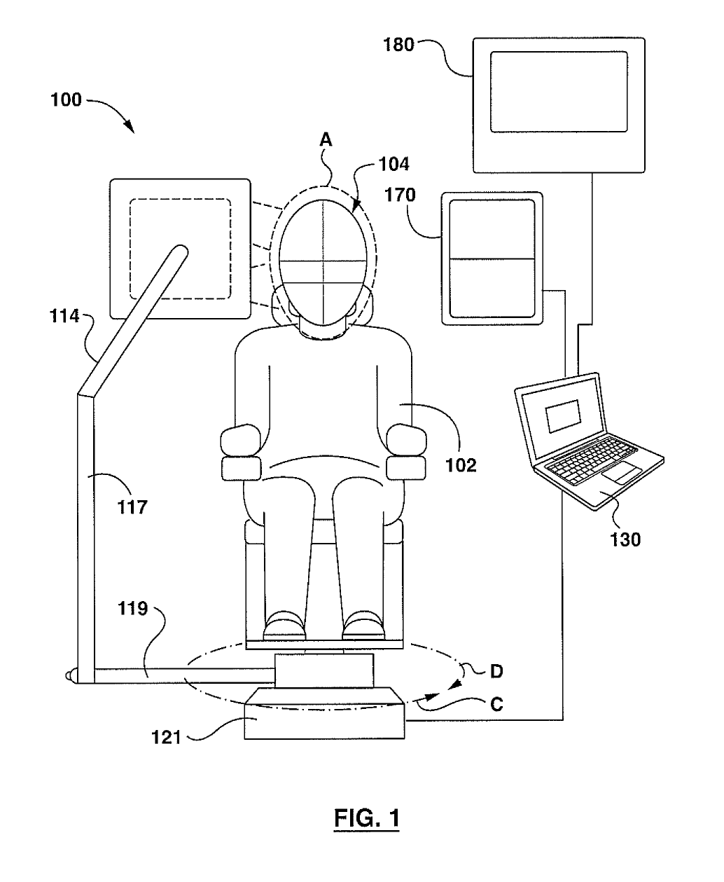

Looking to FIG. 1, the area (as denoted by the area A) exposed to a scan may include at least the coronal aspect of the head posterior to the forehead, the inferior part of the face extending to the chin, and the lateral aspects of the face including the ears (not shown in FIG. 1). The entire anterior view of the face may preferably be included. This area is referred to herein as the “external object”. One scan may be made of the face in at least each of its relaxed stance and a smiling stance. In some embodiments, the scans may comprise substantially real time imagery of the face through a range of positions. For example, this may comprise multiple simultaneous images (or sequential) obtained from various angles along the time span of a smile. This permits the patient 102 or a viewing professional (not shown) to see a smile on, for example, a display screen, with the teeth of choice in the placement of choice. So, not only does displayed is a static smile but the movement of the lips (dynamic smile). If the patient 102 has a well fitted and made set of dentures, the images may be taken with the dentures in situ as this provides support to the lip and assists in determining the shape of a new denture. A purpose of scanning the patient while smiling is to obtain the recording of the rise of the lip, the extent and shape of the opening of the mouth and the exposed facet of the mouth on smiling.

A purpose of the smiling scan is to record the area and shape of the mouth opening upon a smile. That allows the positioning of teeth in the eventual dental device so that the shape of their exposure (view) appears natural and is aesthetically pleasing. The resting image is more appropriate for obtaining the position of the lip and the horizontal plane, and midline. The scanner 110 (See FIG. 1) may include 2 or more sensors 112 (which term is used herein interchangeably with scanners). In some embodiments, visual sensors 112 (e.g., cameras) may be employed and may be placed at at least two positions along a substantially vertical holder 114 (which may itself, comprise multiple and independently moveable and articulable segments 116). The position(s) of different ones of the scanners 112 is preferably such that within their collective functional view are the highest and the lowest relevant points of the external object. The distance of the scanners 112 from the external object is not chiefly pertinent but may be adjusted based on the nature and sensitivity of the sensors 112 and a variety of external factors. The number of sensors 112 need only be sufficient to cover the area discussed herein. Sensors 112 may be mounted in fixed position about the external object 102 and may alternatively and/or additionally be mounted on one or more moving devices 114 which can take sequential or simultaneous images of the external object 102 from various scanning positions (e.g., at various points along range C-D shown notionally in FIG. 1).

While shown in an arrayed, and frame-shaped configuration in the figures, it will be appreciated that rotational or positionally varied scanning configurations may be provided so as to render images from various positions about an axis and/or at different distances from the patient 102 whilst remaining within the scope of the present disclosure.

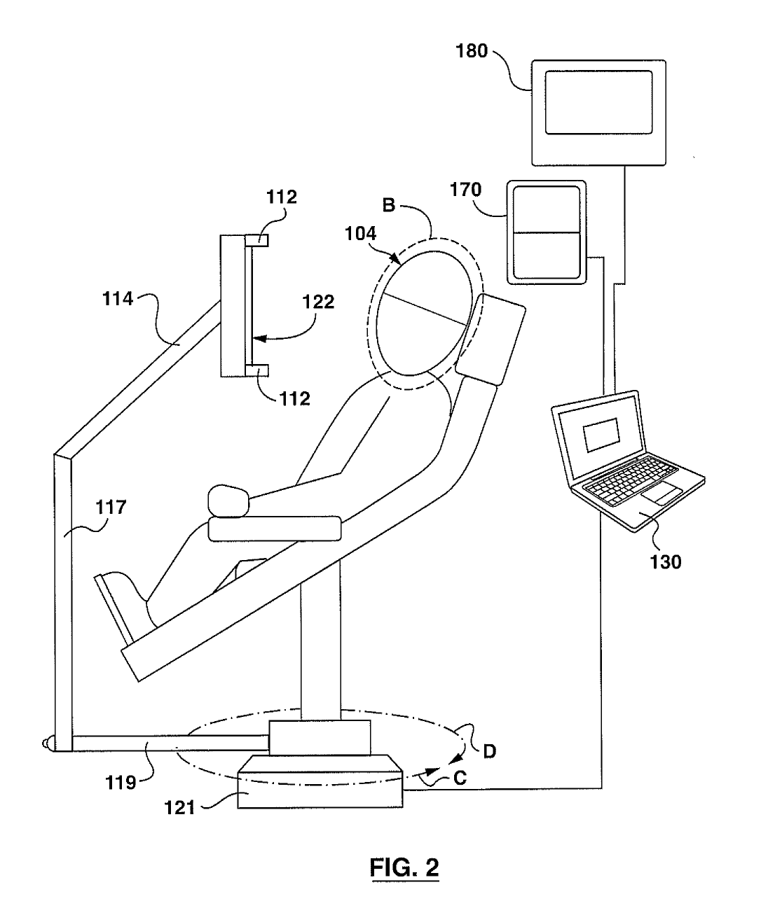

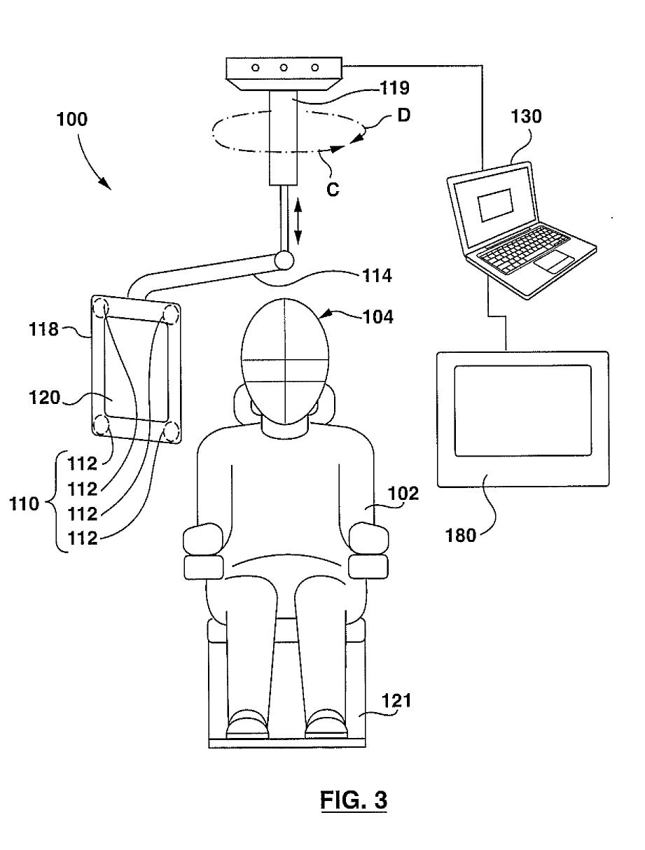

Looking again to FIG. 1 and FIGS. 2 and 3, the scanner 110 may comprise a substantially square frame 116 which may be about 50 cm on each side. The sensor array may be generally similar in shape to a frame, with edges approximately 3 centimeters wide and 3 centimeters thick. Sensors 112, such as high-resolution digital cameras (e.g., the commercially available Realsense™ camera) will be imbedded into the frame 116, at each side, with a total of 4 sensors 112 being preferred. The sensors 112 are placed into the midpoint of the side 118a of the frame outer frame 118. The area bounded by the frame 118 will have a mirror 116 which will operationally face the patient 102. The back of the mirror 116 may have a support element 114 attached thereto and vertically aligned at the substantially the center thereof, connecting upper 116a and lower 116b sides of the frame 116. On the posterior of the support element 114, there will be an attachment element 115 which will be connected to a beam 117, extending substantially to a floor and supported thereby or, alternatively, connected by an extension arm 119 (with or without elbows) to a dental chair apparatus 121.

Inside the periphery of the outer frame 118, there will be placed a lighting element 122, facing the patient's face. The width of the lighting element 122 should be about 2-4 cm and will be shaped to the outer frame 118 in a complementary manner. The lighting element 122 can be a series of imbedded small bulbs or a continuous light, similar to a neon bulb (e.g., 4 bulbs placed, each on each side). The front face of the lighting element 122 will be translucent and coplanar to the mirror 120.

Output of the lighting element 122 will be designed as low IR output or the translucent face of the light will be treated by an IR blocking layer. The sensors 112 will be aimed to be substantially normal to a plane notionally defined by the mirror 120 but with a tilt substantially to the center thereof. For example, if considering the scanner 110 as a 4-sided pyramid with each side of the outer frame 118 being the sides of the 50 cm square base, the apex of this notional pyramid would be set at 50 cm distance from its base. That apex would correspond to the position of the nose of the patient. The sensors 112 would be oriented to center onto the apex.

While a square form of frame 116 is discussed and shown, alternate shaping may be employed with commensurate adjustments in sensor 112 positioning and orientation.

The sensors 112 may be, for example, each two 2 MP or higher resolution video cameras. One camera may employ an IR filter and function primarily to measure depth, and be equipped with an IR laser driven light engine. This engine effectively functions to project an IR grid onto the object A. The sensors 112 output via USB, in some embodiments. Images output are one visual and one IR depth. The components of the system are controlled by a computer 130 included therein.

While examples of sensors are given above, other sensor technologies covering visual and non-visual sensors, different spectrums and geometries, may be used. The end result of the scanning of the patient 102 is a 3D rendering of the scanned object A.

In some embodiments, it is preferable for the engines of three of four sensors 112 to shut down while a fourth is active. This is because the depth measuring routine on the sensor 112 may better function without multiple grid projections from different engines. The sensor 112 may also decrease in effectiveness due to excess ambient IR light. Thus, light sources provided in disclosed systems are preferably IR clean or low, with light applied substantially on all sides as strong but diffuse to avoid creating spot lights and shadows.

The sensors 112 will be activated to obtain images (preferably video) in rapid succession to avoid a change in expression of the patient's face in a given time period. It is preferable to obtain images from all sensors in under about 1 second.

Each sensor 112 is provided with a substantially continuous power source of about 2.5 W and continuous 5 Gb data stream receiver. This is achieved by a data transmission port (e.g., USB port), however, suitably performing wireless connections could be employed if available. The port will be connected to the board of a computer 130 by dedicated connections to each of the ports and thereby to each of the sensors.

The 3D image rendered by the system 100 will be composed by a variety of techniques including the use of the differential angular position of, for example, the two cameras on each sensor 112, the differential position and orientation of each camera with respect to those of the other sensors 112, and the use of fiducial devices 140 associated with the object image.

The scanning devices 112 may also be provided in a desktop format, with a view to scanning, for example, inanimate objects such as dental impressions, prosthetic teeth and dentures. These devices may feature different numbers of cameras, of varying resolutions. They may use different light filters and be set at different geometries. They may or may not use fiducial devices (as herein described) attached or placed upon the scanned object or may use the background of the image, that being the exposed face of the scanning equipment as the fiducial. As an example, in a box shape scanner where the cameras are internal thereto, the inside walls of the box can act as the fiducials.

At least one processor 130 may be provided for processing the results of the scan(s). These results may include images, 3-D scan data, (depth measurement data, angle or orientation measurements) and positional data regarding the external object A. The processing may include, for example, recording, transferring and reviewing of the scan(s), as well as, in some cases, forwarding the data to fabricators. Further, the processor 130 may be configured to alert a user (not shown) as to an error state in the event that a portion of the image or images or rendering is unclear or absent one of more of the sensors 112 has not captured sufficient data to facilitate.

In some embodiments, an impression may be taken of, for example, the upper ridge of the patient's teeth. After this impression has set, another set of scans (e.g., relaxed and then smiling or the reverse order) may be obtained with an impression tray 140 in situ. Taking this further scan with the tray 140 in situ allows the lip 106 to rise when it is provided a certain amount of lip support from the tray 140. A similar level of lip support with the new dentures would be desirable. In the absence of any such support, the lip 106 collapses both when the mouth 108 is relaxed and when smiling. In such circumstance, the shape of the open mouth is very different.

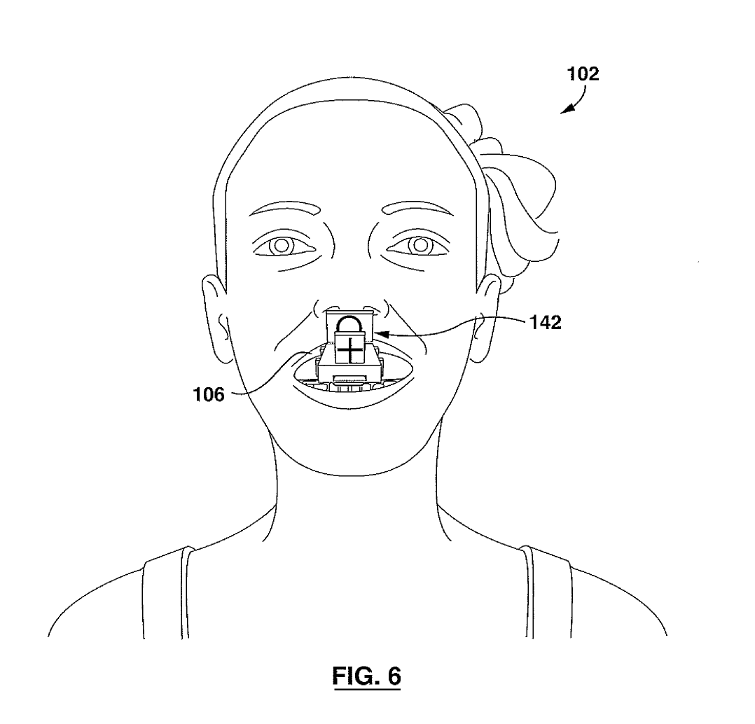

The tray 140 employed should bear traceable indicia 142 suitable for monitoring and providing details of the position and orientation of the tray 140. These positions and orientations may be indicative of positions and orientations of the jaw of the patient 102. The indicia 142 may be provided on a portion 134 integral or attachable to the tray 126. In some embodiments, the indicia 142 may be provided on a cover or sleeve 144 (e.g., in the form of an arm or elbow extending therefrom and fitted for attachment to the tray. For example, the indicia 142 are observable by the scanners 112 when the tray 140 is in the mouth 108. The nature of the observability may vary depending on the nature of the scanners 112. The indicia 142 may comprise a pattern of circles or crosses (see, for example, FIG. 6), suitable for recordation by the sensor 112. In other embodiments, the indicia 142 may be the shaping of an exposed portion of the tray 126 or an attachment thereto, which may be suitable for detection and monitoring by the sensors 112 (e.g., regarding positioning and orientation). Thus, the sensors 112 can, by way of understanding relations between the indicia and the tray(s) 126 detect and determine the precise position and orientation of the tray 140 when in the mouth 108. This may, in some embodiments, provide for substantially real-time rendering of positioning, orientation and movement of the mouth/head of the patient 102. Such imagery may be made available to the patient 102 by way of a screen 150 or in some cases, glasses 142 or virtual reality-type headsets.

The indicia 142 (or “fiducial device”) may be provided as a sleeve, as discussed, that is dressed onto and/or over a retention portion 146 of the impression tray. The fiducial device 142 is provided with one or more indicia 142 thereon, including, for example, geometric shapes. These shapes may be provided in relief, painted, etched and/or with a particular colour scheme. The fiducial device is securely fit to the retention portion 146, and exhibits stability of position. The indicia 142 may preferably comprise clearly and sharply defined geometric shapes. These shapes may among a pre-populated group of known shapes and/or provided in known colours, such that any minor deficiencies in display of the particular shape may be extrapolated such that the position and movement of the tray 140 may nevertheless be clearly defined.

Predetermined characteristics of the fiducial device can be used by the processor 130 to determine the position and orientation of the sensors 112 by comparison of the viewed image to known dimensions.

This also allows determination of depth measurement bias and application of a correction, based on the use of its known measurements. It also allows determination of the position of the upper impression in the mouth (which is invisible to the sensors) by using the tray 140 and indicia 142 as a frame of reference in this scan and in the scan of the impressions. This allows the determination of the 3D positon of the upper jaw with respect to the face 105 and head 104.

In some disclosed embodiments, an additional fiducial device may be used by placement of, for example, a C-shaped apparatus around the head of the patient. The device would also be shaped and configured in a manner analogous to that of the fiducial devices discussed hereinabove.

If using multiple fiducial devices 142, for example, one attached to the upper impression tray 140a and another attached to an impression tray or gauge which is fixed to the lower teeth or gum, the position of the upper jaw with respect to the lower jaw can be determined. A lower impression may then be taken and the process described above may be repeated as with the upper impression.

An exemplary process for bite recordings herein disclosed is detailed below. A bite device 160 may be provided, which comprises a compressible and resilient structure shaped and configured to engage, space and interact with oral appliances. The bite device 160 may in some embodiments have a feel or texture resembling silicone or a rubbery ball (and may be referred to herein as a “bite ball”). The bite ball 160 may deform in what may resemble a “pancake” like structure but has the capacity to recover to or towards its original shape upon removal or reduction of external pressure. The bite device 160 preferably has a slick outer surface, by way of material properties and/or a suitable lubricant applied to it. The device 160 may comprise of two such objects 162, 164, placed one on top of the other. This would permit each of the single objects to slide against each other when compressed between the upper 140a and lower 140b trays when the jaws are moving.

The bite device 160 may be placed onto, for example, the outside, flat face of the upper tray 140a (the set impression being contained inside the tray) and the tray 140 is returned to the mouth 108. The lower tray 140b may then be inserted into the mouth 108 so that the bite device 160 is between (or sandwiched by or intervening between) the trays 140a, 140b and separates them. The trays 140a, 140b should not make direct contact with each other (as that may cause a torque movement of either or both). The patient 102 may then be asked to protrude the jaw and retrude it, and to repeat such actions several times. The patient 102 may then be instructed to move the jaw laterally to each direction and the other, repeating this several times. These movements are recorded by the sensors 112. In some embodiments disclosed herein, the sensor array 112 only needs to record the maximal extensions of the jaw (i.e., anteriorly, posteriorly, right laterally and left laterally). In some cases, the patient 102 may be instructed to bite with maximum force. This compels the patient 102 to position his/her/their mandible in centric bite. This process may be repeated while using bite-balls 160 of a various compressibility values. Thus, the jaw movements are recorded at different separations (vertical dimensions) between the jaws. This permits the interpolation of the jaw movement at any intermediate vertical dimensions and for extrapolation of jaw movement for vertical dimensions exceeding the maximum and minimum recorded vertical dimensions. Accuracy of the predicted motion would be clinically superior to methods currently in use for the production of dental appliances, prosthetics and devices. That accuracy in the predicted motion would be, generally, inversely proportional to the difference between a recorded vertical dimension and the vertical dimension for which the prediction is made.

One advantage of using this method of recording the various bites when compared, for example, to Gothic Pin Arch Tracing, is that the in the pin arch, the contact between the trays is at a single point. As discussed generally above, this renders the trays unstable and may apply torque to them in the mouth 101 so that they are not fully seated on the ridges. The bite device, by contrast, makes a wide and consistent contact base between the arches. The pressure exerted at all points of contact are equalized by the nature of the fluidity of the device. This facilitates a better approximation of normal jaw movements, without unusual external forces (i.e., the force and resultant torque from the pin and resistance thereto). Moreover, the gothic pin is used to determine only the centric bite position. The systems 100 and methods 300 herein disclosed allows for the recording of the relative position of the jaws to each other at any point of movement of the mandible along its range(s) (it should be range of motion not ranges) of motion (i.e., in effect, allowing monitoring of the movement of all components of translation and/or rotational movements).

The importance of accurate determination of ideal or appropriate vertical dimension (VD) is high. Where occluding teeth are present, the natural VD is considered to be the present separation between the jaws when teeth are completely interdigitated. The VD may be adjusted based on other findings or functional and aesthetic objectives but such is directly pertinent to the present disclosure. Where the patient has one or both dentures, the same is determined, from the dentures, as the starting point for establishing the proper VD. Changes in VD cause discomfort to patients and render adaptation to new dentures increasingly more difficult proportionally to the extent of the change in VD. The choice of increasing or decreasing the vertical dimension is an important issue but is based on several clinical findings but is not relevant for this discussion. What is relevant is the ability to record the jaw relationship at any position along the range of motion of the mandible for any and all possible vertical dimensions in this elegant manner so that the practitioner can alter the VD it s/he so chooses. Changing the VD, in the current art is a tedious physical-mechanical operation in which the practitioner needs to trim the height of the bite block or add a layer to it. Only one VD can be set at any given time and the bites must then be recorded at that VD. What technicians sometimes do is alter the VD in the articulator. Thus, the teeth are set to a new VD without ascertaining the actual bite at that new VD. That leads to bite errors which increase in significance proportionally to the degree of the change in VD.

In both techniques, the position of the bite is restricted to a particular separation (vertical dimension) length between the ridges, albeit far more consistently so if using the disclosed systems 100 and methods 300. It is possible to record bite positions for a different vertical dimension by repeating the bite recordings with a different bite balls of different size(s) and/or compressibility. This will render a larger or smaller separation between the trays which translates to a larger or smaller vertical dimension. Bite positions for any infinite vertical dimensions can be deduced from the positions recorded for two distinct vertical dimensions. Additionally, bite positions can be extrapolated for vertical dimensions outlying the recorded positions for the recorded vertical dimensions. In short, this method of recording, obtains precise details of the movement path of the jaw at substantially every degree of opening.

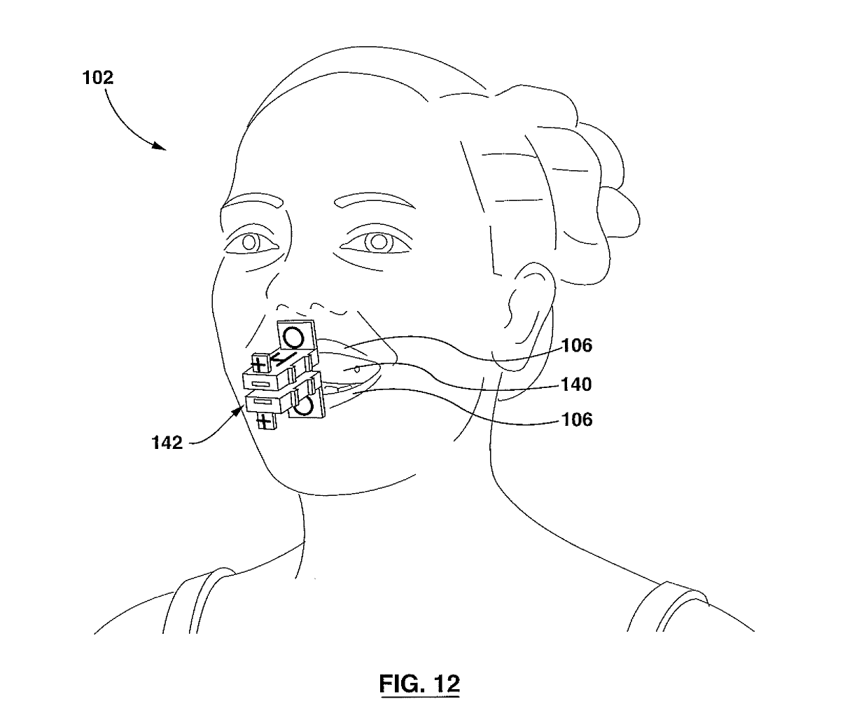

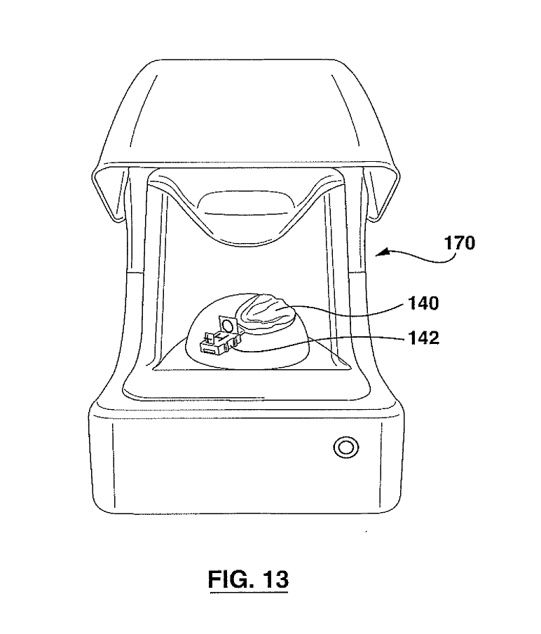

Following completion of the clinical recordings described above, the impression trays (with impression within) may be placed in a commercially available 3D scanning device 170 (see, for example, FIG. 12). The scanning device also records the position of the tray handles 128. The attached computer (processor) 120 is configured to deduce the ridge shape (positive image). The ridge may be positioned within the image of the face using the methods herein disclosed. While the images of the ridges and the head are rendered by use of, for example, commercially available products, it is not known nor has it been suggested to merge these objects in the manner and for the purposes disclosed herein. Further, the results of such merger, in the manner herein disclosed, exceed what may have been apparent based on a consideration of either. This is at least because of the precise placement of the upper ridge with respect to the face, in 3D. This precise placement requires use of the image of the tray handle, in effect, as a transfer device. That image, of the handle, obtained, for example, from the scanned impression tray and from the facial imaging must be superimposed exactly in order to stitch the visible facial (external) image with the hidden (internal) image. This process may be used to stitch any number of separate 3D object images. This particular system of imaging may be used to reveal details of objects otherwise hidden, to leverage this knowledge in other context. It can be very useful for imaging and including objects which are generally hidden from the camera in particular exposures.

At least in this respect there is applicability of the facial scanning techniques discussed herein, beyond the realm of dentistry and denture provision. For example, facial reconstructive surgeons may be avoided by more functional renderings if later seeking to repair damaged features.

Please recall that in the current art, it is known to position the maxilla with respect to the TMJ by use of an object known in the art as a Face Bow. The process of doing so is called Face Bow Transfer. That object allows the 3D fixation of the maxilla to the portion of the device which inserts into both ears. The theory provides for the 3D position of the insertion point in the ears is at least generally correlated to the positon of the TMJ and its orientation. That 3D fixation of the maxilla to the TMJ may be an improvement on the alternative of not doing so at all but is still quite inadequate as it does not account for variability in the relationship between the position of the TMJ and the insertion point in the ears. In the proposed process, this is a non-issue. The maxilla is fixed with respect to the face and additionally, the movements of the mandible relate to the position of the maxilla and the face.

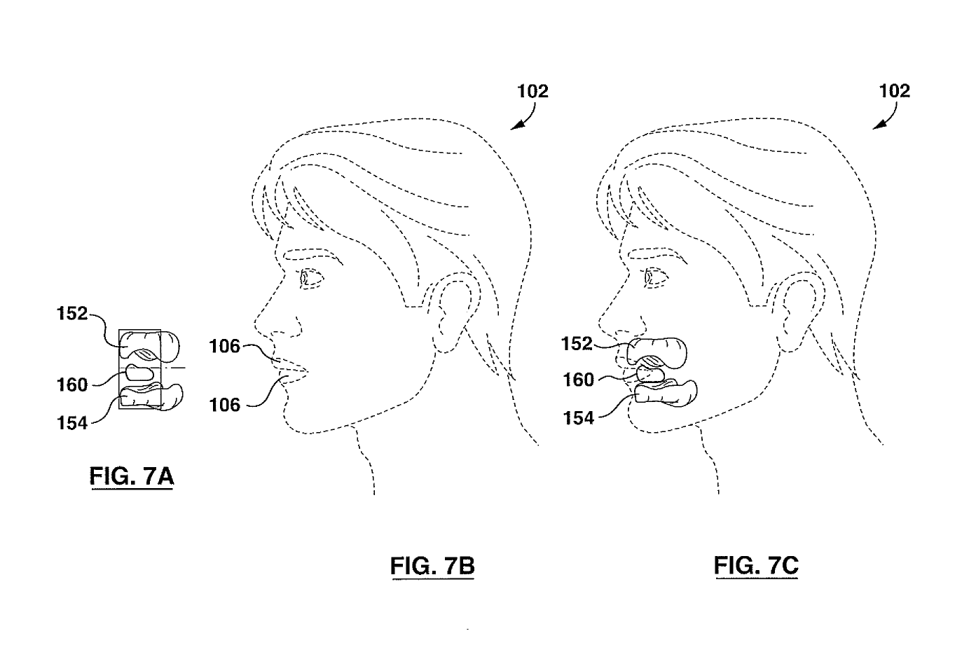

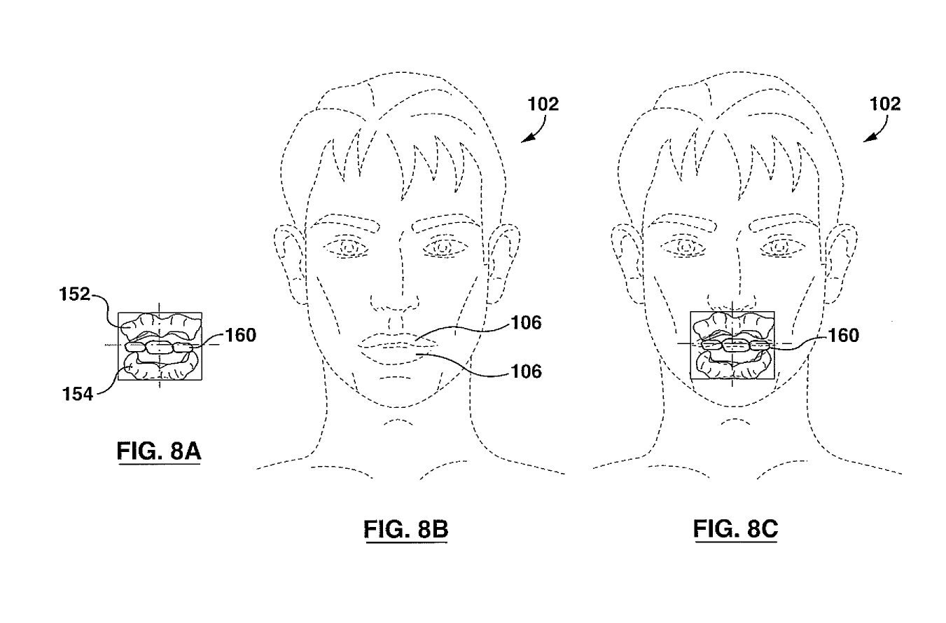

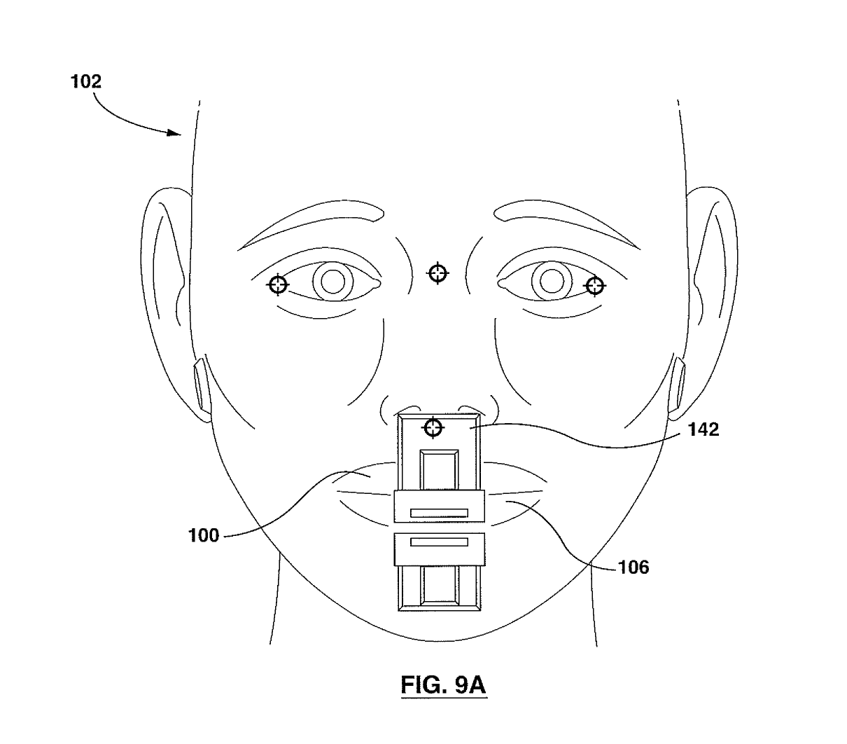

Visualizing the ridge within the image of the face is not disclosed in the known software products herein discussed. In some embodiments, images provided on screen may be split. Looking to FIGS. 7A-C and 8A-C, in some embodiments, one view may show external images (e.g., smiling or relaxed postures), for example, when teeth are placed in position (patient view). Another image may show only the ridges, as appropriate for the construction of teeth (construction view); still another view may demonstrate how changes in position of teeth can effect the overall look (combined view). The upper ridge may be placed inside the image of the face (see FIGS. 7C and 8C) in its accurate position by virtue of this process, without need for multiple try-ins. The midline of the face, the horizontal plane, the corners of the mouth, length of the smile, the inclination of the ridge can all be marked on the image both quickly and accurately; however, these positions can also be overridden easily by a sophisticated user, so as to achieve desired aesthetic properties.

It should be noted that this method of “stitching” can be applied to different forms of images and/or scanning data. For example, placement of a radiographic image of the jaw inside a visual image of the face; relation of a sonographic image to a radiographic image; etc. One skilled in the art will readily appreciate that the above is but an exemplary listing of imaging types that may be used with systems herein disclosed. In some embodiments, provision may be made for relation of any two or more objects to each other whether they physically connected or otherwise. This is based, for example, on a positional relationship between the objects (fixed or dynamic), which relationship maybe recorded using the disclosed systems and methods. For example, an understanding of the geometry of a jaw portion and its relation to a tray may allow for prediction of movements thereof based on monitoring of the indicia discussed hereinabove.

It will be appreciated that the object images may be used to determine distance (by optical imaging means) between the scanners and the objects, based on known dimensions and relative or orientations of such objects. Furthermore, the disclosed methods can record multiple objects that are positionally related to other objects in that group and also record the motion of one object or more and the specific vector of such object with respect to the others in the group.

The setup of teeth in a digital format is, at least in general terms, known, with several software being available for that purpose. These products generally require, as an input, a 3D image of the maxillary and mandibular ridges; however, this image must display these ridges in a particular relation and separation from each other. In such known methods, there is no means to alter the separation of the maxillary and mandibular models. Even if the ability to alter the separation (vertical dimension) does arise in existing software, it would not necessarily incorporate a proper bite recording at a newly chosen vertical dimension. The set-up is also limited to the particular relation between the maxillary and mandibular ridges (centric relation). In known software products generally available for this purpose, a method for relating the jaws to each other has been implemented which aligns the upper and lower jaws based on an algorithm which determines and aligns the centre of the ridges of each jaw to that of the other. This is said to represent the centric bite relationship; however, it is, at best, a crude approximation. More fundamental is the fact that known methods do not and cannot address the issue of vertical dimension. Moreover, known methods do not pertain to protrusive and excursive bite relationships (the relationships between the jaws on biting and chewing). It is more generally accepted in the art that bite recordings must be obtained empirically (clinically). The disclosed systems and methods provide the capability to show not only centric relation but also and importantly demonstration of the relations between the ridges when the jaw moves through (any) variety of positions. This forms the basis of producing and placing teeth with accurate, custom cusp anatomy, rather than using predetermined cusp angles as supplied by manufactures. This provides for the set-up to accommodate tooth contact under normal chewing motion, based on the additional input available by way of the disclosed systems and methods. In contrast, known systems only show the ridges in a specific relation to each other. The disclosed systems and methods allow more accurate set up of teeth, along with viewing of the outcome in real time on the facial image of the patient. In this regard, the patient can actively participate in the process, giving much needed and timely feedback regarding the selection and placement of the teeth. This phase of the process can be completed in minutes, as opposed to being a multi-stage and multi-appointment (week) process necessitating potentially numerous patient consultations (and commensurate costs).

After the set-up is completed, the dental device, or denture, can be fabricated by use of, for example, a manufacturing device 180 such as a 3D printer 180 or similar rendering device suitable for precision construction of articles of the type discussed herein. It is contemplated that the teeth may be printed or otherwise similarly produced, too; however, the base will generally be printed with sockets pre-sized and positioned for the insertion of otherwise fabricated teeth. The teeth to be used must be the same ones that are placed virtually. Therefore, the teeth that are placed virtually must generally be in stock or ordered, as printing and other production technologies advance. When it becomes possible to produce the teeth directly, the molds and shades of the teeth will become unlimited (custom produced). Moreover, the cusp angle of the posterior teeth will not need to comply to those made available by producers. In fact, the cusp angle would be determined and produced precisely to the recorded motion of the jaw. This would render the dentures more stable in the mouth upon movement of the jaw in biting and chewing function. Furthermore, it would reduce or even eliminate the need to mill the occlusion, as is presently customary, to improve the interdigitation of the teeth following placement of the dentures.

It should be noted that the precise determination of cusp angle and contour of crowned teeth in some scenarios, may also, be beneficial. Presently, crowns are produced to achieve contact only at centric bite. Anatomically correct cusps and contours are not the general objectives as the technology has not been available to provide. Posterior crowned teeth are produced which do not generally lend themselves to chewing action by that tooth. The ability to record precise jaw motion also permits the production of a crown which functions ideally as a chewing tooth. It also permits the crown to be produced so that it does not interfere with the motion of the jaw. Finally, the crown produced in this manner can be shaped precisely as to avoid untimely contact with opposing tooth at both centric bite and at any point along the range of motion of the jaw. It is that condition which often stresses a crowned tooth and leads to failure of treatment.

If a trial denture is to be produced, the simpler process is to produce the teeth in a single shade and as a single object resembling the arch. That arch is then joined to the base by use of common annealing method. This can also be the process of production for a faster and less costly product yield

This process is more accurate and allows for the rational design and fabrication of the dentures rather than set-up and determination by trial and error. It allows for the process to be done on guidance of the patient and be completed in a single seating rather than over several appointments spanning several days (or weeks). The digital design process permits the imaging to be stored for repeated fabrication and allow for ease of changes.

This process can also be used for production of crowns and subtypes thereof. Crowns can be produced that are in full anatomical definition and that are in proper bite. They will accommodate the proper contact at all jaw positions and will reduce or avoid the need for bite adjustment. Will also reduce or eliminate tooth trauma caused by improper contact.

This process can also be used for forming orthodontic appliances and other appliances. The key is to be able to represent the proper relationship of the jaws at every possible point of contact between the teeth (with the foreign object in situ) along the mandibles range of motion.

Other than the above, we may have different sources of illumination and may or may not use light engines using different light sources at different frequencies.

As noted, disclosed systems 100 may also include 3D printers 180. The scanner will record the printed object as it is built as well as any fiducial 142 used in conjunction. The purpose of the scanner is this application is to align the printing process from layer to layer. As well, in some printing applications, the size of the printer object is difficult to control and is dependent upon the distance of the print head or lens. The scanner can be used to control the size of the printed object and permit the lens distance to adjust and correct. Where multiple printing phases are used and the printing process needs to be interrupted between them, aligning is essential so that subsequent layers are placed precisely as intended on deeper layers. Scanning the print and determining its position is highly advisable.

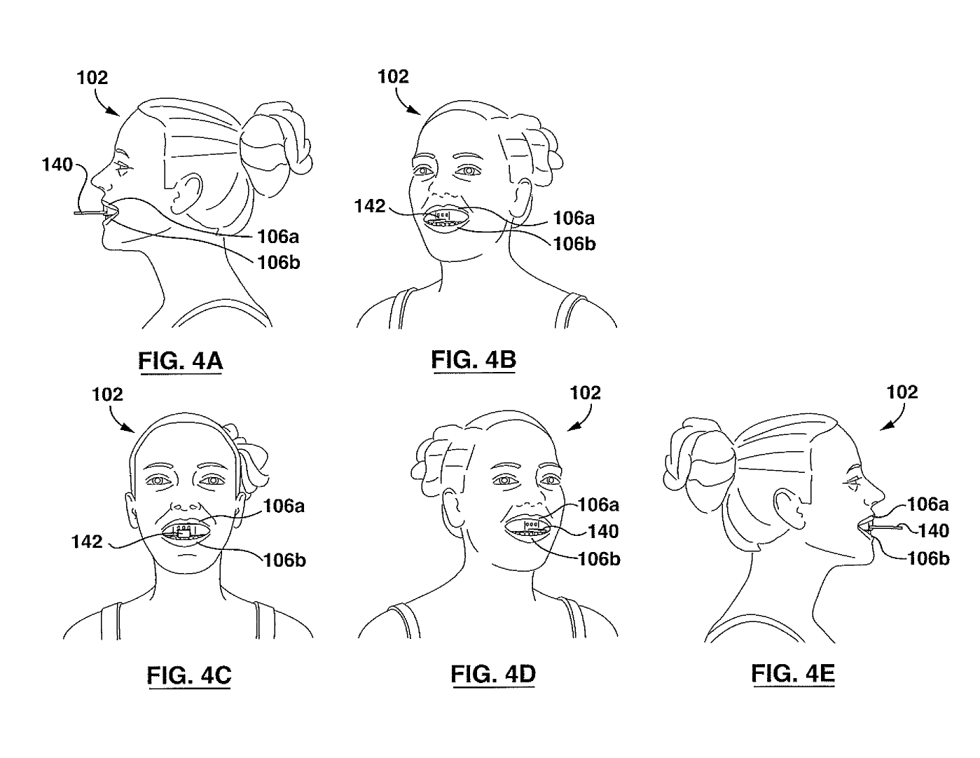

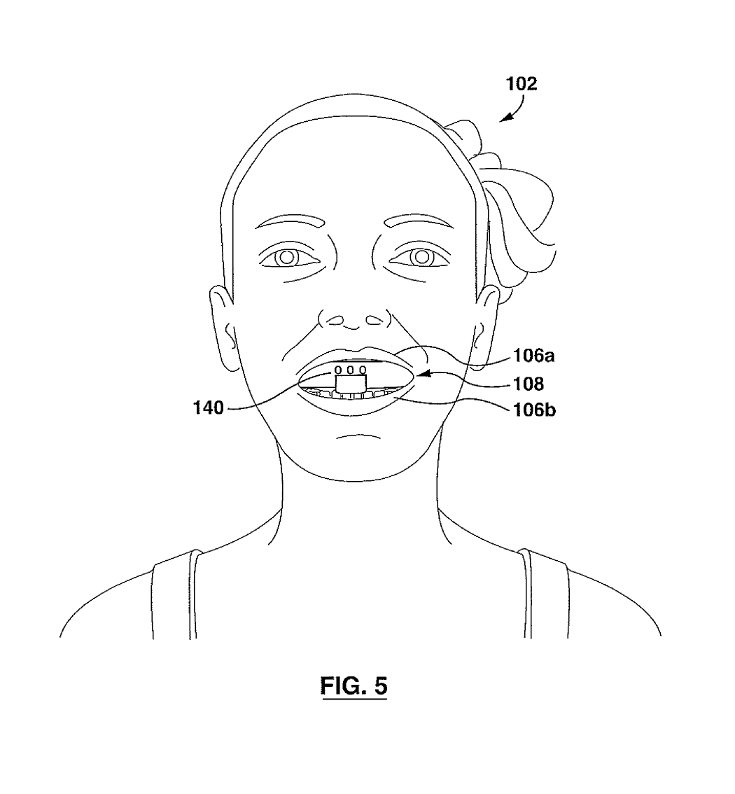

To recapitulate, recording is important in the assessment of a patient vis-à-vis denture formation. Beyond recording the relative position of the jaws to each other (orientation and distance), there is also provide means for recording an animated scan of the movement of the jaw. That is, a series or recordings while the jaw moves from side to side and from front to back. In addition, similar recordings of opening and closing movement of the jaw. See, for example, the progression of positions shown in FIGS. 4A to 4E. While shown in sequential order of movement, disclosed systems 100 need not have image capture performed in such order (though it may in clinical situations be more expedient to proceed in a defined sequence of patient movements and/or positions). The processing of these various positions and movements, allows for a substantially complete record of jaw motion for a given patient. This record is very useful in determining the existence and/or extent of jaw—related issues. These include, for example, TMJ issues and others, all of which are important to note in terms of setting the position(s) of teeth for when preparing dentures and/or crowns. Other prostheses can also be made by way of the information gleaned in creating the record. These include, for example, orthodontic appliances, TMJ-disorder therapy devices, bruxism appliances.

Disclosed systems also provide for recording of movement of the jaw at different openings (i.e., vertical dimensions). Recording of related images allow for calculation of the motion of the jaw and any intervening levels of opening and even outside of the range (i.e., interpolation and extrapolation, respectively). Dental impression trays (i.e., upper and lower) may be scanned separately. Since there is at least one fiducial device attached to the tray, that impression can be used to determine the position of the tray within and about the head of the patient. Where there are at least two impressions taken, with each tray having a fiducial device attached, the bite and relative position of the impressions with respect to each other, is also determined.

Alternative methods for determining disclosed herein includes by having only an upper impression 140a with fiducial device 142. However, the impression tray 140 can be double sided and thereby, take a concurrent impression of the lower jaw and dentitition. Where a supplementary lower impression is taken, the two impressions can be matched (i.e., superimposed) to obtain a record of the bite.

The vertical dimension can be controlled in this scheme by placing stoppers inside the lower tray segment of the double-sided tray. This will ensure that the distance between the jaws, when taking the impression, is wider.

After completing a scan of the face of the patient, the resulting scan is displayed to the patient 102 and user (not shown) for review on the screen 150. The patient 102 may rotate it to generally face front and centre. The clinical user may then in the image mark the outside angle of each eye of the patient and outside angle of the lips in the scanned image. This permits making of adjustments to the orientation of the face, its size (i.e, the size is not altered but only its appearance is altered to zoom it to occupy about 50% or more of the viewing screen). This can be done because the eyes are expected to be level and face front and be at the same depth to the monitor.

In some disclosed embodiments, impressions may be taken and scanned in for later review remotely with patients. This may be more prevalent in jurisdictions wherein denturists are not accredited and dentists or the like perform similar work. In such embodiments, the patient may interact with a technician who would remotely assess the accumulated 3d models of the patient's face and jaws. Depending on local requirements for professional testing prior to delivery, some dental devices may then be fabricated remotely and shipped to the patient (or, if required, to the dental professional). The process can be segmented, in that fabrication could be performed separately from the analysis and modelling.

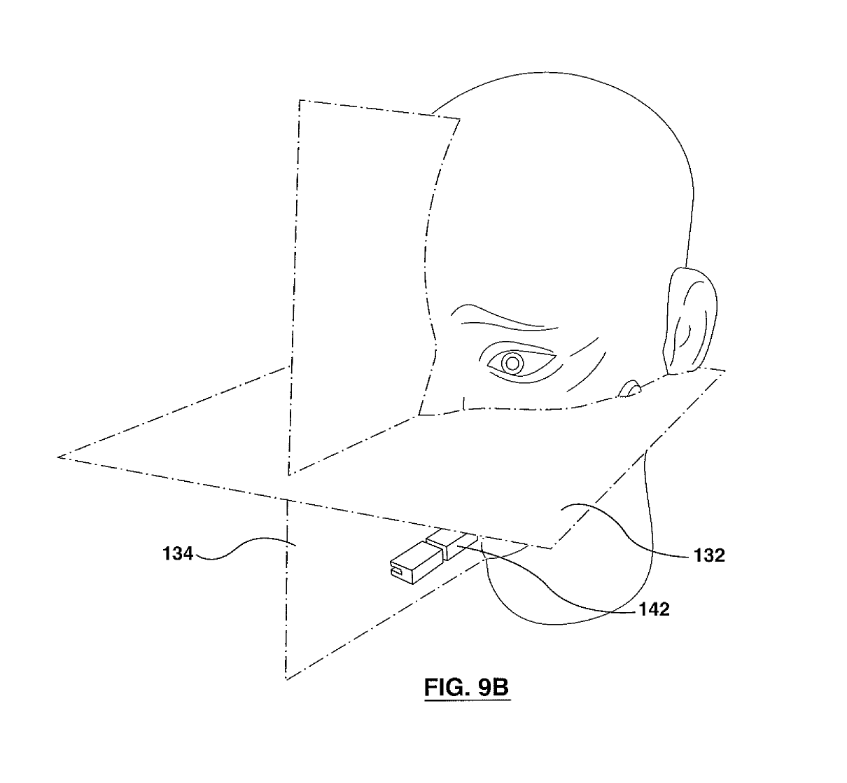

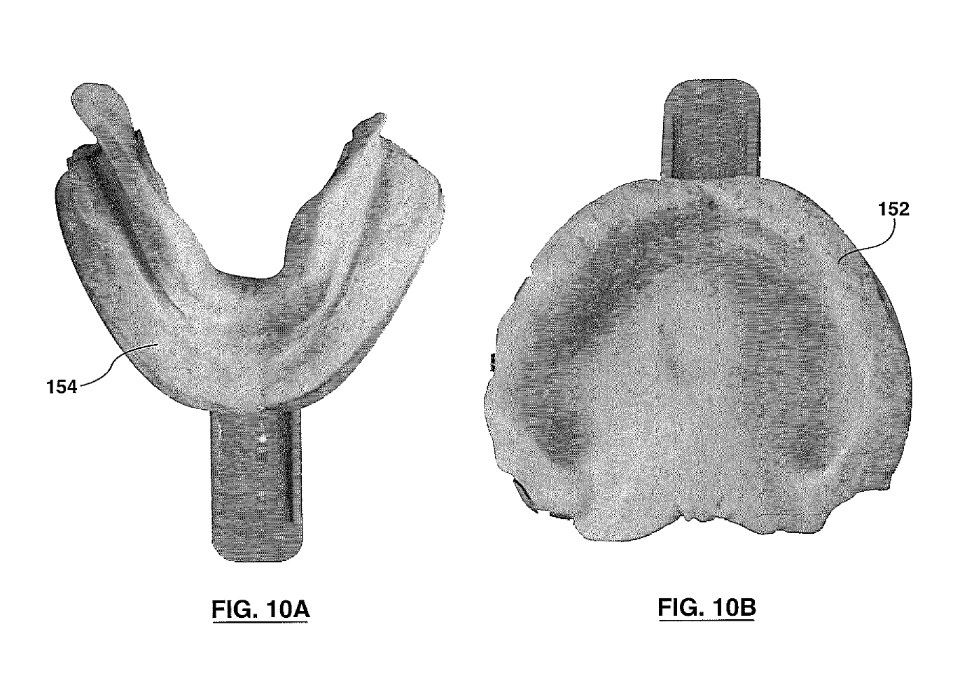

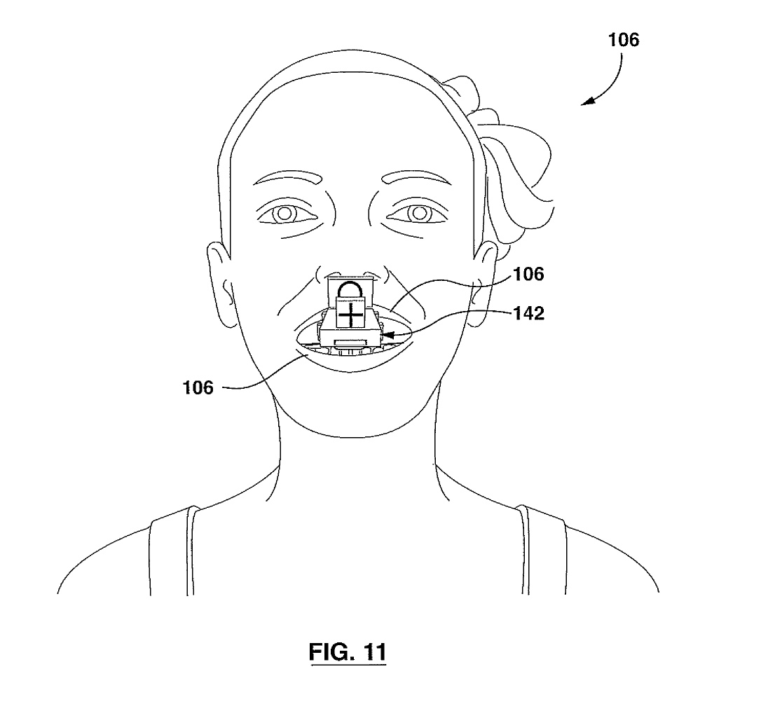

The markings, discussed above, also permit the formation of planes which map the face 108. As shown in FIG. 9B, coronal 132 and mid-sagittal 134 planes are produced which. The user may then adjust the position of the coronal plane 132 in the frame down from the eyes to be at the level of the separation between the lips. This is the position at which teeth should generally be placed.

On a second screen, the impressions are displayed. The user selects the area of the impression which is of interest. The tray and handle are outside of the needed anatomical area. The excess of the image is cropped. The user can effect a transformation which converts the impression (negative) into the model (positive) of the jaw in question. The user may then effect corrections to the model where the user sees defects stemming from the impressions. After completion of the prepping of the models, they are positioned in bite.

The models are adjusted to be placed in correct orientation to each other and in the same orientation as is in the face. The planes from the face are duplicated to the models automatically, as well. This will indicate a proper placement for teeth.

The user can adjust the inclination of the coronal plane to the anatomy of the mandible in line with the user's experience and knowledge. The anatomy indicates the height of the plane at the posterior as it needs to be at the level of the retromolar pads. As for the front of the plane of occlusion, it needs to be at the level of the lip separation. These positions can be adjusted further to achieve aesthetic objectives. Any change of the plane position in the display of the jaws, will effect a concurrent change in the display of the image of the patient's face.

The user will first mark the mandibular ridge to indicate the horizontal position of the teeth. The height is determined by the coronal plane (now called the plane of occlusion). The user can measure the length of the posterior segments of the mandible and the length of the anterior arc. These will correspond to the length of the teeth to be selected.

The user will select teeth from a library of teeth which will provide an appropriate length. These will then deposit automatically onto the occlusal plane, substantially directly vertical to the marked lines on the mandible. Where upper and lower teeth are placed, they will be positioned on the plane, articulated automatically.

As teeth are placed onto the occlusal plane, they will also appear in the face image, concurrently. This will enable the user and patient to see the design as will be in the smile of the patient. The user can then apply the provided feedback to design and construct the appearance of choice. This acquisition of feedback may occur prior to physical rendering of an actual product, with an opportunity for such feedback to be used to alter the denture design prior to fabrication and without inspection or trying of a completed physical product.

Once tooth placement has been determined, the base may be fabricated. The borders of the base will be indicated by the user. The user can, in effect, “paint” the base onto the model with the borders as indicated. The user can also adjust the borders as suitable. The user can further effect a transformation which will give the painted region, thickness and vary the thickness as desired. The user can add layers where the body of the denture is thicker. When the user approaches the height of the teeth, the user can effect an automatic (programmed) connection to the teeth. The point of contact and orientation of the base to the tooth at the point of contact is determined by a library routine.

A library may be provided, and populated with scans of existing teeth from various commercial producers thereof. These teeth will be mapped to indicate their vertical axes and the correct faces (outside face, inside face, occlusal surface). A ring will be modelled around each tooth, at its neck. This ring is the contact line between the denture body and the tooth.

After building the denture base, this image is sent to a rendering device, such as a 3-d printer or 3-d mill. Sockets may be created in the base around each tooth (up to the determined contact point) and can be automatically increased in size, by a particular factor. 100 Um may be necessary to accommodate errors in the printing process or an actual incorrectly produced tooth. This will ensure that the teeth can be inserted with little to no difficulty into the socket.

The fabricated denture base will be added to by insertion of the teeth into their socket. The annealing of the teeth can be done by use of light-curable resin or other known means.

It is not uncommon for patient to wish to change a denture upon taking it home. Existing dentures may be readily remade by way of the disclosed systems and methods, for example, by taking impression in the mouth, inside the existing dentures (or even in the patient's old dentures). The prior denture, then, effectively serves as the impression tray. Scan may be performed with the patient's dentures in situ, as may supplementary impression with an impression tray position, for example, on top of the patient's dentures. This provides a frame of reference for the teeth and for the bite. As discussed above, the appearance may then be considered and adjusted by way of computer modelling, to the patient's desires and/or clinical needs, and new dentures fabricated.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field,” such claims should not be limited by the language under this heading to describe the so-called technical field. Further, a description of technology in the “Background” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

All of the systems and methods disclosed and/or claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A system for creating a dental device for use in a mouth of a patient, the system comprising:
a) a scanning device comprising a plurality of sensors;
b) a processor in electronic communication with the scanning device;
c) an impression tray;
d) a fiducial device connected to the tray and shaped and configured to provide tracking data to the sensors when the tray is operationally positioned in the mouth;
wherein the plurality of sensors is collectively adapted to monitor and capture tracking data regarding the impression tray and transmit such tracking data to the processor; and,
wherein the processor is adapted to an render electronic image of a dental device suited to the needs of the patient based on the orientation data and movement data.

2. The system according to claim 1, wherein the scanning tracking data comprises orientation and position of the tray.

3. The system according to claim 1, wherein the device comprises a frame for retaining the sensors in desired positions relative to the patient.

4. The system according to claim 3, wherein the scanning device further comprises a mount selectively holding the frame in and moving between a plurality of monitoring positions.

5. The system according to claim 3, wherein the sensors comprise a plurality of video cameras.

6. The system according to claim 5, wherein the frame comprises a substantially square outer frame portion and an inner frame portion, wherein the inner frame portion is mirrored and operationally directed towards the patient, and wherein the cameras are attached to the outer frame portion.

7. The system according to claim 5, wherein the fiducial device comprises a retention portion and one or more visible indicia comprising relief characteristics, colour, shape, and wherein the visible indicia are formed, etched, or marked.

8. The system according to claim 7, wherein the fiducial device is integrally formed with the impression tray and visible outside the user when the impression tray is in the mouth.

9. The system according to claim 1, wherein the system further comprises an output device for providing a viewable electronic rendering of the dental device in and about the mouth.

10. The system according to claim 9, wherein the system further comprises a fabrication device for producing the dental device based on the rendering.

11. The system according to claim 10, wherein the fabrication device comprises a 3-dimensional printing device.

12. An impression tray for use in creating a 3-dimensional rendering of one or more body parts of a patient, the tray comprising:
a) a retention portion for fixing the tray relative to the patient;
b) an indicator portion connected to the retention portion and bearing one or more visible indicia;
wherein the retention portion comprises one or more members shaped to receive a bite of the patient; and, wherein the indicia comprises relief characteristics, colour, shape, and
wherein the visible indicia are formed, etched, or marked on the tray.

13. The tray according to claim 12, wherein the indicator portion and retention portion are integrally formed.

14. A method of scanning the face of a patient, the method comprising the steps of:
a) placing an impression tray in the mouth of the user with one or more visible indicia outside the mouth;
b) scanning a plurality of images of the face of the patient using a plurality of sensors while the patient moves its jaw through a set of positions and movements;
c) processing the images using a computer to form an electronic rendering of bite positions of the patient;
d) further processing the images using the computer to generate an electronic rendering of a dental device in the mouth;
e) outputting to a visual output device imagery of the rendering for review;
f) adjusting one or more parameters of the rendering based on the review; and,
g) fabricating the dental device by a fabrication device in electronic communication with the processor.

15. The method according to claim 14, wherein the fabrication device comprises a 3-dimensional printing device.

16. The method according to claims 14, wherein the method further comprises additionally outputting imagery of a bite sequence of the patient.

17. The method according to claims 14, further comprising the step of creating a 3-dimensional scan of an impression tray.

18. The method according to claims 14, further comprising the step of positioning a bite ball between upper and lower portions of the impression tray prior to the scanning.
